(19) United States
(12) Patent Application Publication
(10) Pub. No.: US 2014/0031003 A1
(43) Pub. Date: Jan. 30, 2014

(54) METHODS AND SYSTEMS FOR PROVIDING EMERGENCY CALLING

(71) Applicant: Bandwidth.com, Inc., Raleigh, NC (US)

(72) Inventors: Jason Shugart, Denver, CO (US); Jason Sommerset, Mt Hood Parkdale, OR (US)

(73) Assignee: Bandwidth.com, Inc., Raleigh, NC (US)

(21) Appl. No.: 14/043,413

(22) Filed: Oct. 1, 2013

Related U.S. Application Data
(60) Provisional application No. 61/708,907, filed on Oct. 2, 2012.

(51) Int. Cl. H04W 4/22

(52) U.S. Cl. CPC H04W 4/22
USPC 455/404.2

(57) ABSTRACT

Embodiments of the present invention are directed to handling of emergency calls originating from mobile devices. Embodiments of the present invention may include features implemented on the mobile device and/or on elements of the carrier's network to provide enhanced location determination and routing of the emergency call. These features and functions may take advantage of various sources of location information and provide enhanced routing and other functions based on this information. Embodiments may provide enhanced workflows or other functions associated with the handling of the emergency call. For example, modes of communications available to the mobile device may be selected and utilized instead of or in addition to a voice call in various situations. In other examples, various workflows or other processes may be kicked off upon the initiation of an emergency call from the mobile device to, for example, provide notifications to various other parties.

### CROSS-REFERENCES TO RELATED APPLICATIONS

The present application claims benefit under 35 USC 119(e) of U.S. Provisional Application No. 61/708,907, filed on Oct. 2, 2012 entitled “Methods and Systems for Providing Emergency Calling,” of which the entire disclosure is incorporated herein by reference for all purposes.

### BACKGROUND OF THE INVENTION

Embodiments of the present invention relate generally to methods and systems for supporting emergency calling and more particularly to determining and using location information in the handling of emergency calls made from mobile devices and providing other enhanced emergency call functions.

Emergency calls placed to 9-1-1 from a fixed landline may be easily routed to a proper public safety system such as a dispatcher for local fire or police agencies based on a known physical location at which the landline is installed. However, mobile devices such as cell phones present challenges in dealing with emergency calls. Particularly, determining a current physical location of that device when an emergency call is placed has proven to be a signifimayt challenge. In fact, emergency calls placed from mobile devices are sometimes routed to a public safety system that is not appropriate, e.g., the system to which the call was routed serves a different locale than the actual location from where the mobile device was when the call was placed. Additionally, considering the ever increasing processing power and other capabilities of mobile devices, functions and features related to the processing or handling of emergency calls from mobile devices are surprisingly lacking. Hence, there is a need for improved methods and systems for determining and using location information in the handling of emergency calls made from mobile devices and providing other enhanced emergency call functions, especially in conjunction with mobile communication devices.

### BRIEF SUMMARY OF THE INVENTION

Embodiments of the invention provide systems and methods for determining and using location information in the handling of emergency calls made from mobile devices and providing other enhanced emergency call functions. More specifically, embodiments of the present invention may be directed to routing and other handling of emergency calls, i.e., 911 calls, originating from mobile devices including but not limited to mobile devices such as cellphone, smartphones, PDAs, tablets, netbook computers, notebook computers, etc. Embodiments of the present invention may include features implemented on the mobile device and/or on elements of a carrier's network to provide enhanced location determination and routing of the emergency call. These features and functions may take advantage of various sources of location information and provide enhanced routing and other functions based on this information. Additionally or alternatively, embodiments of the present invention may provide enhanced workflows or other functions associated with the handling of the emergency call. For example, modes of communications available to the mobile device, e.g., text, email, streaming video, etc., may be selected and utilized instead of or in addition to a voice call in various situations. In other examples, various workflows or other processes may be kicked off upon the initiation of an emergency call from the mobile device to, for example, provide notifications to various other parties. Various additional details of embodiments of the present invention will be described below with reference to the figures.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a block diagram illustrating elements of an exemplary environment in which emergency call handling may be performed and in which embodiments of the present invention may be implemented.

FIG. 4 is a flowchart illustrating a process for determining location of a mobile device making an emergency call according to one embodiment of the present invention.

FIG. 5 is a flowchart illustrating a process for determining which available location information to use for a mobile device making an emergency call according to one embodiment of the present invention.

FIG. 6 is a flowchart illustrating another process for determining which available location information to use for a mobile device making an emergency call according to one embodiment of the present invention.

FIG. 7 is a flowchart illustrating a process for providing additional messages related to an emergency call according to one embodiment of the present invention.

FIG. 8 is a flowchart illustrating a process for taking actions based on detection of a dial sequence according to one embodiment of the present invention.

FIG. 9 is a flowchart illustrating a process for using an email message in conjunction with an emergency call according to one embodiment of the present invention.

FIG. 10 is a flowchart illustrating a process for bridging a third party to an emergency call according to one embodiment of the present invention.

FIG. 11 is a flowchart illustrating a process for bridging an emergency call to an established call between parties according to one embodiment of the present invention.

FIG. 12 is a flowchart illustrating a process for encoding a message related to an emergency call according to one embodiment of the present invention.

FIG. 13 is a flowchart illustrating a process for decoding a message related to an emergency call according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

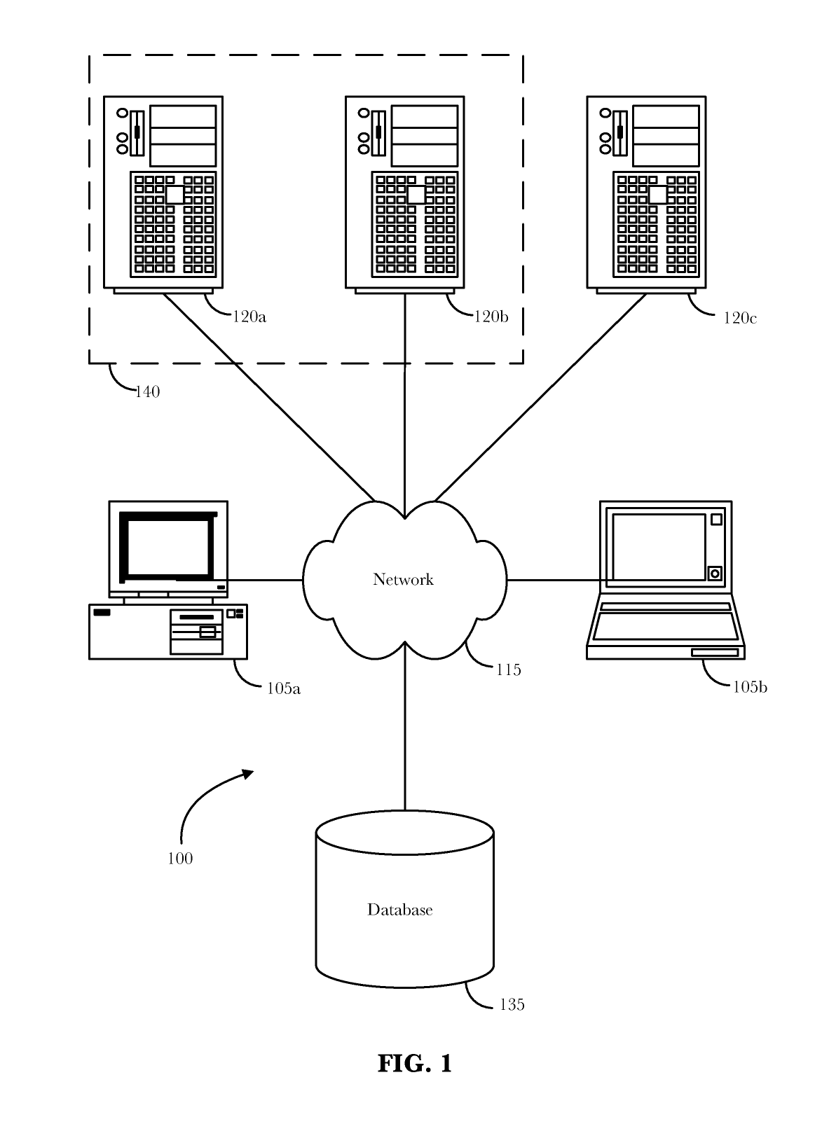

FIG. 1 is a system block diagram illustrating components of an exemplary operating environment in which various embodiments of the present invention may be implemented. The system 100 may include one or more user computers 105a-b which may be used to operate a client, whether a dedicated application, web browser, etc. The user computers 105a-b may be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, a variety of GNU/Linux operating systems). These user computers 105, 110 may also have any of a variety of applications, including one or more development systems, database client and/or server applications, and web browser applications. Alternatively, the user computers 105a-b may be any other electronic device, such as a thin-client computer, Internet-enabled mobile telephone, and/or personal digital assistant (PDA), capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network 115 may be any type of network familiar to those skilled in the art that may support data communications using any of a variety of commercially-available protocols, including without limitation TCP/IP, SNA, IPX, AppleTalk, and the like. Merely by way of example, the network 115 may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system 100 may also include one or more server computers 120a-c which may be general purpose computers and/or specialized server computers (including, merely by way of example, PC servers, UNIX servers, mid-range servers, mainframe computers rack-mounted servers, etc.). One or more of the servers (e.g., 120) may be dedicated to running applications, such as a business application, a web server, application server, etc. Such servers 120 may be used to process requests from user computers 105. The applications may also include any number of applications for controlling access to resources of the servers 120.

A web server may run an operating system including any of those discussed above, as well as any commercially-available server operating systems. The web server may also run any of a variety of server applications and/or mid-tier applications, including HTTP servers, FTP servers, CGI servers, database servers, Java servers, business applications, and the like. The server(s) 120 also may be one or more computers that may be capable of executing programs or scripts in response to the user computers 105, 110. As an example, a server 120 may execute one or more web applications. A web application may be implemented as one or more scripts or programs written in any programming language, such as Java™, C, C# or C++, and/or any scripting language, such as Perl, Python, or TCL, as well as combinations of any programming/scripting languages. The server(s) 120 may also include database servers, including without limitation those commercially available from Oracle®, Microsoft®, Sybase®, IBM® and the like, which may process requests from database clients running on a user computer 105.

In some embodiments, an application server may create web pages dynamically for displaying on an end-user (client) system. The web pages created by the web application server may be forwarded to a user computer 105 via a web server. Similarly, the web server may receive web page requests and/or input data from a user computer and may forward the web page requests and/or input data to an application and/or a database server. Those skilled in the art will recognize that the functions described with respect to various types of servers 120 may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105 or servers 120. Alternatively, it may be remote from any or all of the computers 105 or servers 120, and/or in communication (e.g., via the network 115) with one or more of these. In a particular set of embodiments, the database 135 may reside in a storage-area network (“SAN”) familiar to those skilled in the art. Similarly, any necessary files for performing the functions attributed to the computers 105 or servers 120 may be stored locally on the respective computer and/or remotely, as appropriate. In one set of embodiments, the database 135 may be a relational database, such as Oracle 10g, that is adapted to store, update, and retrieve data in response to SQL-formatted commands.

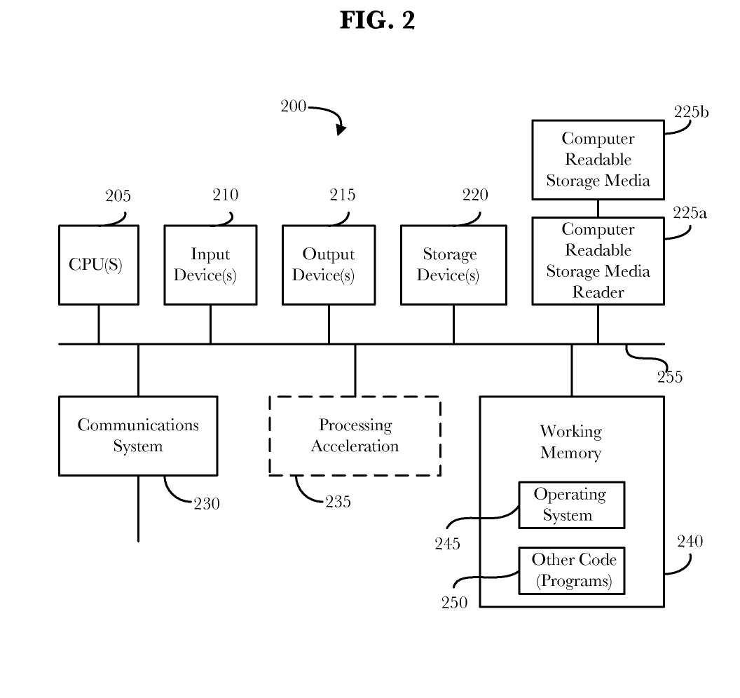

FIG. 2 illustrates an exemplary computer system 200, in which various embodiments of the present invention may be implemented. The computer system 200 may be used to implement any of the systems 100 described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage devices 220. By way of example, storage device(s) 220 may be disk drives, optical storage devices, solid-state storage device such as a random access memory (“RAM”) and/or a read-only memory (“ROM”), which may be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which may include a digital signal processor (DSP), a special-purpose processor and/or the like.

The computer-readable storage media reader 225a may further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 115 and/or any other computer 105 or server 120 described above with respect to the system 100.

The computer system 200 may also comprise software elements, shown as being currently located within working memory 240, including an operating system 245 and/or other code 250, such as an application program (which may be a client application, web browser, mid-tier application, RDBMS, etc.). It should be appreciated that alternate embodiments of computer system 200 may have numerous variations from that described above. For example, customized hardware may also be used and/or particular elements may be implemented in hardware, software (including portable software, such as applets), or both. Further, connection to other computing devices such as network input/output devices may be employed. Software of computer system 200 may include code 250 for implementing embodiments of the present invention as described herein.

For example, any of the networks, servers, computer, and mobile devices described above may be utilized to implement an emergency calling system in which embodiments of the present invention may be implemented. As noted above, embodiments of the present invention may be directed to routing and other handling of emergency calls, e.g., 911 calls, originating from mobile devices including, but not limited to, mobile devices such as mobile phones, cell phones, smartphones, PDAs, tablets, netbook computers, and notebook computers. Embodiments of the present invention may include features implemented on the mobile device and/or on elements of a carrier's network to provide enhanced location determination and routing of an emergency call. These features and functions may take advantage of various sources of location information and provide enhanced routing and other functions based on this information. Additionally or alternatively, embodiments of the present invention may provide enhanced workflows or other functions associated with the handling of an emergency call. For example, modes of communications available to a mobile device such as text, email, streaming video, etc., may be selected and utilized instead of or in addition to a voice call in various situations. In other examples, various workflows or other processes may be kicked off upon initiation of an emergency call from the mobile device to, for example, provide notifications to various other parties.

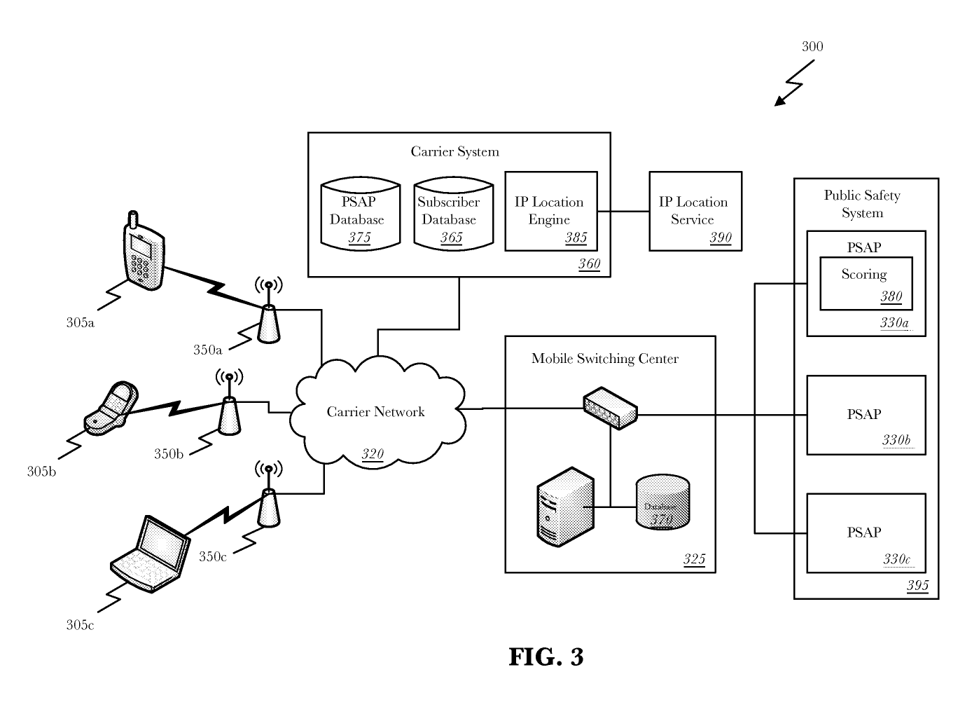

FIG. 3 is a block diagram illustrating elements of an exemplary environment in which emergency call handling may be performed and in which embodiments of the present invention may be implemented. As illustrated here, the emergency call handling system 300 may include a number of mobile devices 305a-c of various types as noted. These mobile devices 305 may be communicatively coupled with a carrier network 320 and carrier system 360 for sending and receiving any of a wide variety of electronic communications as known in the art. For example, the carrier network 320 may comprise a cellular network and associated carrier system 360 as known in the art. Additionally or alternatively, the mobile devices 305 may be wirelessly communicable with the Internet and/or another local area or wide area network (not shown here), for example, via one of the 802.11 protocols (e.g., WiFi), Bluetooth, or other channel as noted above and as known in the art. WiFi is a trademark of the Wi-Fi Alliance—an industry association promoting the standardization and interoperability of wireless local area network (WLAN) connectivity based on the IEEE 802.11 series of standards. Wi-Fi wireless technology allows devices to connect and access the Internet directly or through a router without any physical association with a wired network. The 802.11 standards are a group of evolving specifications defined by the Institute of Electrical and Electronic Engineers (IEEE). Now commonly referred to as Wi-Fi, the 802.11 standards define a through-the-air interface between a wireless client and an access point or between two or more wireless clients. In these embodiments the carrier network 320 and carrier system 360 are not necessarily a cellular implementation and may also be a Voice over IP (VoIP) implementation utilizing one or more interconnected IP data networks including the Internet and any associated routing equipment and other infrastructure.

Through any of the carrier network 320 or other network, the mobile devices 305 may place emergency calls, i.e., 911 calls, to an appropriate public safety system 395. For example, the system 300 may also include a mobile switching center 325 that may be part of the carrier network 320. As known in the art, the mobile switching center 325 may receive and route calls and other communications to and from mobile devices 305. In the case of an emergency call, the mobile switching center 325 may determine which of any number of Public Safety Answering Points (PSAPs) 330a-c the call should be routed to based, for example, on the location of the caller and a defined geographic area for which the PSAP 330 is responsible.

For any particular type of emergency service, the service provider may provide the location of the subscriber placing an emergency call. Sometimes, there may be two or more types of location that may be determined by the mobile device 305. A first location may be determined by a GPS receiver (if available) within the mobile device 305. A second location may be determined by the carrier network 320 and/or carrier system 360 by triangulating a wireless signal between cell sites (e.g., basestation towers) 350a-c. For wireless services, it may take a while to get a location measured in latitude and longitude by either of these means. However, the mobile switching center 325 may route an emergency call based on a more coarse location such as a known location of the cell site 350 through which the emergency call is received. This works in many, even most, situations but not all. And, once emergency services are on the way or as they approach the initial location, a better, more accurate location may be needed.

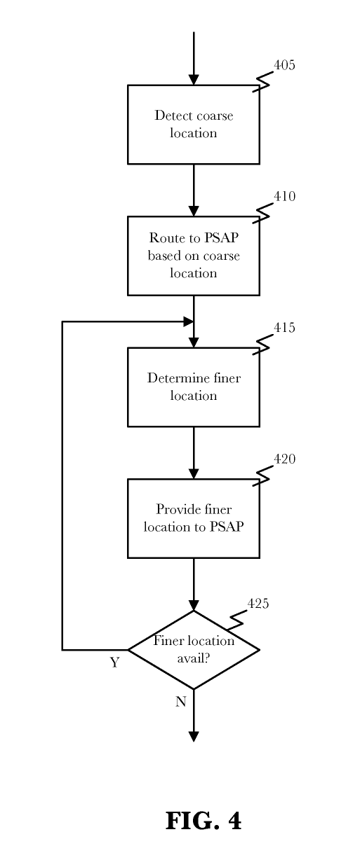

FIG. 4 is a flowchart illustrating a process for determining location of a mobile device 305 making an emergency call according to one embodiment of the present invention. As illustrated in this example, determining a location of a mobile device 305 making an emergency call may comprise detecting initial coarse location information of the mobile device 305 at block 405. For example, the initial coarse location information may be based on a known location of a cell site 350. The emergency call may be initially routed at block 410 to a PSAP 330 based on the initial coarse location information. Finer, more accurate location information may be determined at block 415 based on, for example, a GPS receiver in the mobile device 305 or other means including cell site 350 triangulation. The finer location information may then be provided at block 420 to PSAP 330. If at block 425 even finer and more accurate location information becomes available, the finer location information may again be determined at block 415 and provided at block 420 to PSAP 330.

For example, some PSAPs 330 may request location accuracy to within four (4) inches. The reason being, if it might be necessary to force entry, e.g., break down a door or wall, emergency responders should know which side of the door or wall a caller is on. But, having that type of accuracy is only necessary in those situations. In other situations and at different stages of responding, less accuracy is acceptable. For example, as long as the call is first routed to the right PSAP 330 and emergency responders are first directed to the right neighborhood, and then to the right house or building, increasing accuracy with time may be acceptable.

One solution may be to provide location information to the PSAP 330 in two stages. That is, the call may be first routed to a PSAP 330 by the mobile switching center 325 based on an initial coarse location and then the latitude and longitude may be provided to the PSAP 330 when it is determined. But in some cases, there may be only one methodology for determining location depending upon the type of equipment used. For example, if the calling device is a static handset (e.g., a plain old telephone service POTS), location may be determined based on a record created when the equipment is installed. If the device used is nomadic such as a VoIP device, the subscriber may enter a location upon registration and this registration information may be used for the location. If the mobile device used includes wireless capability, the cell site 350 location and latitude and longitude may be used.

However, a number of trends are developing related to and indicating other potential sources of location information. For example, applications are available for mobile devices 305 that operate to detect the station or computer (not shown here) the mobile device 305 is docked with when connecting to a docking station. So, if mobile device 305 knows a current specific location (like an office number etc.) or if the computer system to which mobile device 305 is docking has a location and may share it with the mobile device 305, the mobile device 305 may determine location and may use this instead of or in addition to private branch exchange (PBX) information or the carrier's information when placing an emergency call.

In another example, some applications may utilize maps of floor plans inside of buildings and determine locations within these mapped building based on sensor input such as magnetic fields. This technique may supplement GPS or triangulation data that may be faulty or unavailable inside of buildings. Using these kinds of applications, a location may be determined by the mobile device 305 when inside of the building that could be better than the traditional sources. In such cases, these locations may be made available by the mobile device 305 rather than relying solely on the traditional location sources.

According to one embodiment, the carrier system 360 may make available a database 365 of subscriber information at least when that subscriber is making an emergency call. That information may include location information for a subscriber making the call. According to one embodiment, the mobile device 305 could possibly detect the availability of this information and query or request a location from the carrier system 360. The subscriber information may also include self-reported medical history data that may be of value to emergency responders. For example, the subscriber may be diabetic and that information may help an emergency responder in assessing a situation upon arrival at a scene.

In yet another example, WiFi access points may also be a source of location information for use by the mobile device 305 and/or mobile switching center 325. Mobile devices 305 often include 802.11 WiFi transceivers for exchanging IP data via a WiFi network access point. Location information may be available from the WiFi network access point itself, e.g., preset for a particular installed location, when the mobile device 305 is connected to the WiFi access point. In other cases, it may be determined from a directory of WiFi network access points maintained by a network operator such as the carrier system 360, mobile switching center 325, or third party. According to one embodiment, this information may be queried by the mobile device 305 and/or the network operator or carrier to obtain such location information.

Incomplete location data for a 911 VoIP caller is frequently a problem for Over-The-Top (OTT) and Long Term Evolution (LTE) service providers that do not have access to cellular location data or GPS location data. In such cases, the carrier system 360 may include and use an IP location engine 385. Generally speaking, the IP location engine 385 may provide an interface to one or more known IP location vendors to obtain raw wireless access point IP location data for a mobile device 305 placing an emergency call. Once the wireless access point IP location data is obtained by the IP location engine 385, the carrier system 360 may integrate that wireless access point IP location data into a VoIP emergency call.

Another consideration may be the vertical axis. For instance, if inside a building, which floor is the caller on. One implementation may use an altimeter in the mobile device 305 to determine elevation. Here, the carrier network 320 and carrier system 360 may help by correlating location to a known building and thus map the location and altitude to a floor of the building.

These different sources of location information may all have a different level of accuracy. In general, the accuracy of location information may be inversely proportional to the time required to obtain it. When determining location, an initial consideration may be which location information to use. In many cases, the first information to use may be the quickest information available that is accurate enough for use by the mobile switching center 325 in routing the call to the correct PSAP 330. For example, in many cases a particular cell site 350 sector may be mapped in a database 370 of the mobile switching center 325 to a PSAP 330 and the emergency call may be initially routed by the mobile switching center 325 based on this mapping. Triangulation by the carrier network 320 and/or GPS of the mobile device 305 may then be used to determine a more exact location. However in some situations, PSAPs 330, 335, and 340 may be so closely spaced that uniquely mapping a cell site 350 sector to a one particular PSAP 330 is not possible. In such cases, initial routing by the mobile switching center 325 may instead be based on a different location determination, such as triangulation by the carrier network 320 and/or GPS of the mobile device 305 or another source as noted above.

According to one embodiment and to address such initial location determination problems, the phone or mobile device 305 may periodically query a PSAP database 375 of the carrier system 360 indicative of known congested areas and determine based on the mobile device's 305 then current location whether it is in or near such an area. When the mobile device 305 is in such an area, it may pick one type of location information for initial routing other than the network-based mapping of cell site 350 sectors to PSAPs 330. The mobile device 305 or carrier network 320 and carrier system 360 may then select a different, more accurate type of location information to be provided to the mobile switching center 325 and PSAP 330 after the initial routing by the mobile switching center 325. In some cases, the mobile device 305 may perform a periodic check of location by different means and maintain a list of the different locations determined by the different means so that they may be available for use upon initiation of an emergency call.

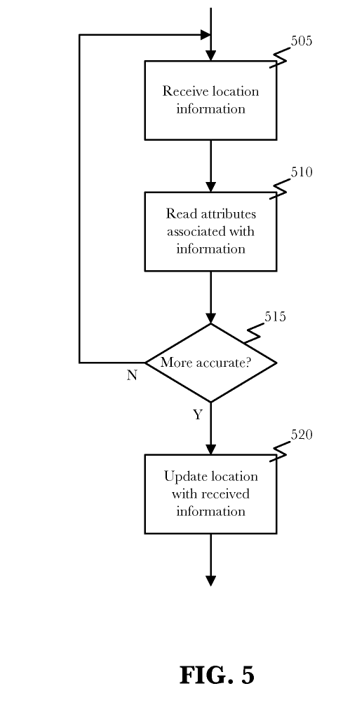

FIG. 5 is a flowchart illustrating a process for determining which available location information to use for a mobile device 305 making an emergency call according to one embodiment of the present invention. As illustrated in this example, determining which available location information to use for a mobile device 305 making an emergency call may include receiving at block 505 location information from or about the mobile device 305. One or more attributes associated with the location information and indicating is accuracy and/or reliability of the location information may be read at block 510. Based on these attributes, a determination may be made at block 515 as to whether the received location information is more or less accurate that what is already known. If it is determined at block 515 that the received location information is more accurate than what is already known, the location of the mobile device 305 may be updated with the received information at block 520.

According to one embodiment, the carrier network 320, carrier system 360, and/or the public safety system 395 or network may also be able to assign different attributes indicative of the accuracy of the received location information. For example, it may be known to the operators of carrier network 320 and/or the public safety system 395 that a particular network may be unreliable in a certain area or under certain conditions. When a call is received from such an area or under those conditions, the initial cell site 350 location information or triangulation or GPS location information received from that mobile device 305 and/or that carrier network 320 may be identified by or assigned an attribute by the mobile device 305, carrier system 360, or mobile switching center 325 indicating that it should be considered less accurate. In such cases, location information from other means may be determined by the carrier network 320 or public safety system 395 to be more accurate and/or reliable. Additionally or alternatively, the mobile device 305 may periodically or on demand check these attributes which may be stored, for example, with the subscriber information of the carrier system 360 to determine whether to provide a different type of location information in the event an emergency call is placed.

According to one embodiment, one attribute that may be assigned to location information may be an indication of authentication or an authentication level. So for example, location information verified or known as being provided by the carrier system 360 may be given a very high authentication level indicative of its reliability, e.g., the low likelihood that the location is being spoofed or otherwise tampered with. Conversely, other types of location information determined locally by the mobile device 305 from GPS and/or other sensor(s) may be given a relatively low authentication level.

According to one embodiment, multiple different types of location information may be provided by the mobile device 305, carrier system 360 and/or the carrier network 320 along with the attributes, such as reliability and/or authentication level attributes. The location information to be used by the mobile switching center 325 and/or PSAPs 330 may then be selected by a call handling application of the mobile switching center 325 and/or PSAPs 330 based on these attributes.

According to one embodiment, a hybrid approach may also be used wherein the carrier network 320 and/or carrier system 360 may make a location determination. The mobile device 305 may also determine a set of location information along with different attributes and provide these to the carrier system 360. The carrier system 360 may then judge, based on the attributes of the location information which, if any, of the location information provided by the mobile device 305 may be used, either instead of or in addition to that determined by the carrier network 320 and carrier system 360. Thus, the carrier network 320 and carrier system 360 may play a role in determining location by creating the list as may be required but also by factoring in location information from various applications on the mobile device 305 that may give better location information.

So, there are many different methodologies for determining location, both locally at the mobile device 305 and/or at the carrier network 320 and carrier system 360, and more are likely to become available. Embodiments of the present invention are directed to using more of these available methodologies and determine, in a given situation of for a given call, which one or more of these to use and when. For example, when outside, GPS on the mobile device 305 may be the most reliable and accurate location determination method available. But, if the caller then moves indoors, the GPS signal may be lost and another method such as WiFi registration and/or triangulation, may be more accurate and reliable. Additionally or alternatively, multiple sources of location information may be used to cross-check or verify each other and may help to improve the overall accuracy and reliability.

So according to one embodiment, a scoring system 380 may be used to rate or evaluate different sources of location information. According to one embodiment, the scoring or weighting applied to these different sources of location information may be determined by the PSAPs 330 and administrators or managers thereof. For example, home alarm systems create many false alarms. Thus, public safety systems 395 require that such systems not directly connect to the public safety systems 395 but rather first route to a call center of the system operator. In-vehicle systems initially fell into the same model and requirements. However, many public safety systems determined that these systems, in many cases, were reliable enough to allow direct routing. So for example, if the in-vehicle system detects an airbag deployment, that call may be routed directly to a public safety system 395 rather than first to a call center for the operator of the in-vehicle system. So similarly, as various location information sources are found to be accurate and reliable enough for direct use by PSAPs 330, these sources may be provided instead of or in addition to the traditional and current sources.

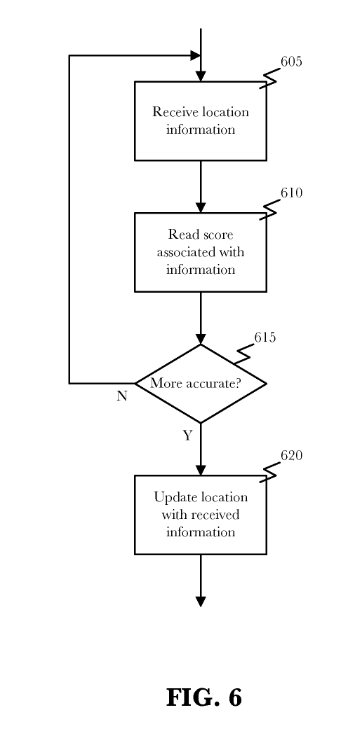

FIG. 6 is a flowchart illustrating another process for determining which available location information to use for a mobile device 305 making an emergency call according to one embodiment of the present invention. As illustrated in this example, determining which available location information to use for a mobile device 305 making an emergency call may include receiving at block 605 location information from or about the mobile device 305. One or more scores associated with the location information and indicating is accuracy and/or reliability may be read at block 610. Based on these scores, a determination at block 615 may be made as to whether the received location information is more or less accurate that what is already known. If at block 615 the received location information is more accurate that what is already known, the location of the mobile device may be updated at block 620 with the received information.

To do so, the PSAPs 330 may rely on direct, manual feedback from the operators and/or dispatchers of those systems indicative of which sources of location information may be considered by them to be most accurate and most reliable in various situations. Additionally or alternatively, this process may be automated by the PSAPs 330 by monitoring which location information is selected by operators and/or dispatchers in various situations over time. As the different sources of information are used, they may accumulate a score. When that score reaches a particular threshold, it may be made automatically available to the PSAPs 330. This score may also comprise a weight for comparing the relative expected accuracy and/or reliability of a particular location information source. Thus, if multiple sources of location information are available for a particular call, the PSAP 330 may select and/or order the available sources for presentation to an operator or dispatcher based on the score.

According to one embodiment, the mobile device 305, the carrier network 320, and/or carrier system 360 may generate and send one or more of a variety of different types of messages to one or more interested parties in addition to the public safety system 395. So for example, if a mobile device 305 located on a school campus places an emergency call, a message may also be sent from the mobile device 305, the carrier's network 320, and/or carrier system 360 to a public safety office for the campus. In another example, if a mobile device 305 used by a minor child is used to place an emergency call, a message may be sent to a parent or guardian of the child and/or other interested (e.g., pre-defined) persons. Other such examples in which interested persons, who may be predefined and stored in a list of emergency contacts in the mobile device 305 or carrier system 360 or who may be determined dynamically, in real-time or near-real-time by the mobile device 305 or carrier system 360 based on an originating location of the call, are contemplated and considered to be within the scope of the present invention. In any of these cases, the additional message may comprise, for example, a text message, an email message, a pre-recorded voice message, a text transcript or voice recording of the call, or any one or more of a variety of other messages and message types which are contemplated and considered to be within the scope of the present invention. Any or all of these different types of messages sent to different entities may also include location information from one or more sources.

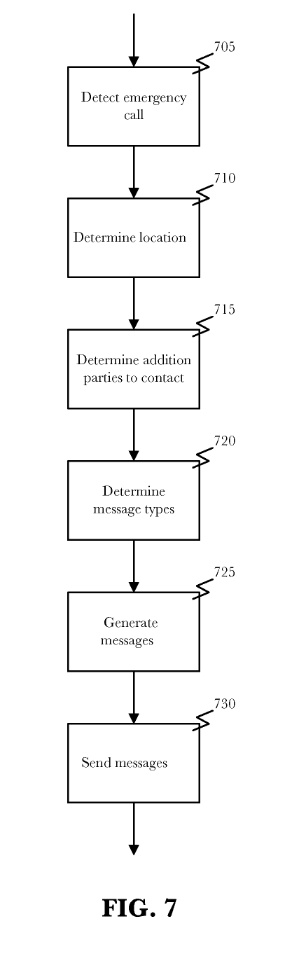

FIG. 7 is a flowchart illustrating a process for providing additional messages related to an emergency call according to one embodiment of the present invention. As illustrated in this example, providing additional messages related to an emergency call may include detecting at block 705 the emergency call and determining at block 710 a location of the mobile device 305 making the call as described above. Additional parties to be contacted may be determined at block 715, for example based on pre-defined subscriber information for the user of the mobile device making the call. A message type for each message to be sent may also be determined at block 720. The determination at block 720 may also be based on pre-defined subscriber information for the user of the mobile device 305 making the call. One or more messages of the types determined at block 720 may be generated at block 725 and sent at block 730 to the recipients determined at block 715.

Embodiments of the present invention may include identification that certain digits were dialed on a mobile phone and the initiation of ancillary services useful to the user that dialed the number, e.g., 9-1-1. There may be two components of such embodiments. A first component may be the identification that certain digits were dialed. A second component may be using the dialed digits to trigger certain other ancillary services.

There may be several ways to identify that certain digits have been dialed. For example, the mobile device 305 operating system may gather dialed digits to place calls. A routine may be added to the mobile device 305 software sub-system to report the digits dialed as a real-time event. In another example, there may be a register of previously dialed numbers used by the mobile device 305 software sub-system to facilitate redialing numbers. If this register may be interrogated by a non-phone application, it may be used to determine which digits have been dialed. Also, an application may be written and executed by the carrier system 360, public safety system 395 or any other system that invites the user to dial certain numbers. This non-phone application may capture the digits entered and then simultaneously deliver them to the mobile device 305 to be dialed and another application that delivers the desired ancillary services.

Once an application becomes aware of the fact that certain digits were dialed, other ancillary services may be delivered by the carrier system 360, public safety system 395 or other system. These services may take the form of a workflow of other resident functions or applications or the initiation of another application. Examples of ancillary services to be performed if the digits 9-1-1 are dialed may include but are not limited to:
Notification to pre-selected individuals. For example, a parent may want to be called if a child dials 9-1-1;
Notification to an adult with an elderly parent; and/or
If the user of the phone has information on their phone or may gather information on their phone that is related to the emergency being reported, this information may be passed to public safety and/or other entities. For example, a person witnessing a crime in progress may want to take video of the event with their phone and send it to the public safety organization that they reported the crime to.

In the example of 9-1-1 being dialed, it would be useful to take advantage of functionality on the mobile device 305 to compliment the reporting of a crime. In these cases, the mobile device 305 may be capable of capturing video, still photos, typed notes, voice notes, the location of the phone, etc. This information may be transmitted to others using the voice capabilities of the phone, SMS service, email, file transfer, and any other communications capability available on the mobile device 305.

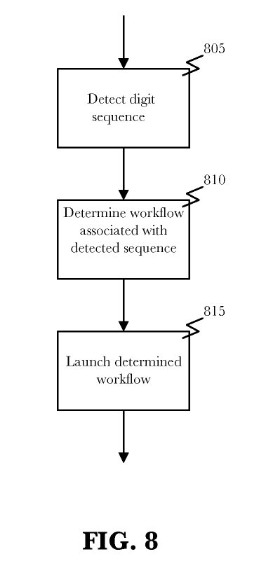

FIG. 8 is a flowchart illustrating a process for taking actions based on detection of a dial sequence according to one embodiment of the present invention. As illustrated in this example, taking actions based on detection of a dial sequence may include detecting at block 805 the particular sequence as described above. Based on the sequence detected at block 805, a workflow may be determined at block 810 or identified that is associated with that sequence. The workflow that is associated with the dialed sequence may then be launched at block 815 to implement the pre-defined actions of that workflow.

Embodiments of the present invention may additionally or alternatively include using a standard email address (e.g., username@domain.com) to store and transfer information from the mobile device 305 and/or carrier system 360 to a predetermined recipient. For ease of implementation and to support the widest range of mobile devices 305, embodiments may use any common address book and any email system.

As for the structure of the email address, the domain name may be that of the predetermined recipient or another one that anticipates the delivery of the message and is equipped to handle it. The local-part, or username may contain the payload and may be composed of two parts. The first part may be the actual payload. Usernames may be very long and may be limited to 64 octets or characters. By encoding data as suggested herein, large amounts of data may be stored in the username. The local-part of the e-mail address may use ASCII characters such as:
Uppercase and lowercase English letters (a-z, A-Z);
Digits 0 through 9;
Characters ! # $ % & ′ * + − / = ? ̂ _ ‘ { | } ˜; and/or
Character . (dot, period, full stop) provided that it is not the first or last character, and provided also that it does not appear two or more times consecutively.

The second part of the username may be a code that identifies the username as acceptable to the receiving email system. By placing a code in the username in a predetermined location, the receiving email system may distinguish this email address from others and thus not treat it as spam since the username of the email is not a valid user on the receiving system. Thus, no setup for the specific username is required on the receiving email system.

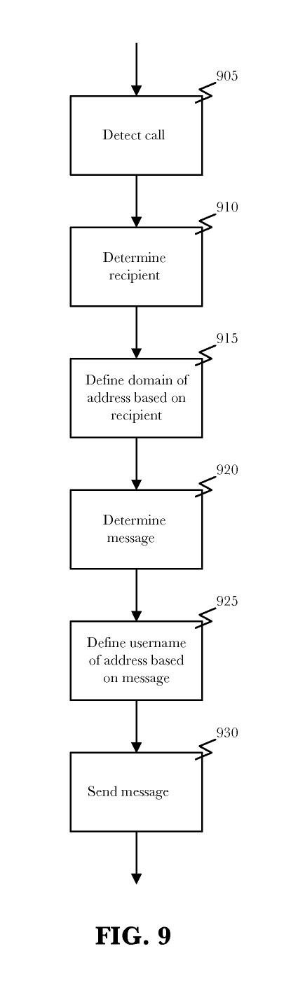

FIG. 9 is a flowchart illustrating a process for using an email message in conjunction with an emergency call according to one embodiment of the present invention. As illustrated in this example, using an email message in conjunction with an emergency call may include detecting at block 905 the call and determining at block 910 a recipient of the message to be sent. The determination at block 910 may be based on pre-defined subscriber information for the user of the mobile device 305 making the call. A domain to which the email will be addressed may be defined at block 915 based on the recipient determined at block 910. A message to be sent to the recipient determined at block 910 may also be determined at block 920 dynamically or based on pre-defined subscriber information for the user of the mobile device 305 making the call. A username of the address to which the email will be sent may be defined at block 925 based on the message determined at block 920. The email may then be sent at block 930 addressed to the domain defined at block 915 and username defined at block 925.

Since the domain name is valid and pre-determined, email systems will deliver the email to the desired email system even if the local-parts (e.g., username) is not known to that system. The receiving email system may be set up such that local-part that fit the profile are accepted and processed. This may be handled in several ways. For example, a standard email spam filter may use the format as a mask to determine valid local-parts (even if they are not registered) and pass them along for processing. Additionally or alternatively, the spam filter may be shut off and messages may go into a file for processing by an application that looks for the approved format and code and processes each message accordingly. In yet another example, both the spam filter and a secondary application may be used together to capture the desired messages. Whichever method is used, the desired messages may be accepted by the system and the data may be processed.

By conforming to the Internet Engineering Task Force (IETF) standards for email addresses, any address book may be used to store the message and any email system may be used to transmit the message. Since specific implementation of email servers may not recognize the differences between uppercase and lowercase characters, only lowercase characters may be used in some implementations. Also, by storing the email address in the address book, sending an email to that address requires very few keystrokes.

This method is useful for sending information that is not prone to change and is not situational. If additional information that relates to the current time, place, or situation is used, it may be added to the email itself Since this requires additional keystrokes, this should be kept to a minimum, however, it does allow for entering security information such as a personal identification number (PIN) or instructions for processing such as additional places to send the data. To accomplish this, the user of the mobile device 305 may go into the address book, select a pre-loaded address and go through the normal process of sending an email or text message to an email address. The receiving email system, such as the public safety system 395, the mobile device user's insurance company, or other system, may then process the email as indicated but then also interrogate the actual email message for additional information. Further action could then be taken based on the additional information.

Additionally or alternatively, embodiments may provide enhanced 911 emergency calling features and functions for hybrid mobile devices device that are capable of switching between cellular communications and VoIP when a WiFi network is available. When a customer of such a service initiates an emergency call while connected to WiFi, the call nonetheless may default to the cellular network. However, if the emergency call maynot complete via the cellular network due to unavailability, the emergency call may revert back to the WiFi network and connect to a national call center. With a VoIP call established by the carrier system 360, a robust bridge for additional communication points to participate on the 911 call may be established by the carrier system. For example, the carrier system may create a conference bridge and include third parties on the call between the emergency caller and dispatcher. In another example, the emergency caller could be a child and the conference bridge established by the carrier system 360 could automatically notify and bridge a parent (via a known alternate telephone number saved in the subscriber database 365) to assist emergency personnel (e.g. 911 dispatcher) on the call. In yet another example, the emergency caller could be elderly and the conference bridge established by the carrier system 360 could automatically notify and bridge an adult child or other caregiver (via a known alternate telephone number saved in the subscriber database 365) to assist emergency personnel (e.g. 911 dispatcher) on the call.

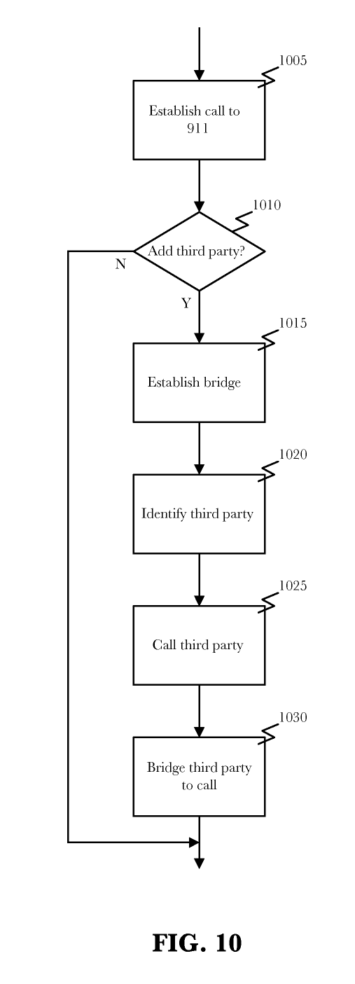

FIG. 10 is a flowchart illustrating a process for bridging a third party to an emergency call according to one embodiment of the present invention. As illustrated in this example, bridging a third party to an emergency call may comprise establishing at block 1005 a call from the calling mobile device to a public safety system. A determination may be made at block 1010 as to whether to add a third party, e.g., a conference option may be selected. In response to determining to add the third party at block 1010, a bridge may be established at block 1015, the third party may be identified, e.g., based on an indication received from the user of the mobile device making the emergency call, the third party identified at block 1020 may be called at block 1025, and bridged at block 1030 to the emergency call without causing the original caller to disconnect the emergency call.

In some cases, two people may be on a call when an emergency situation occurs necessitating a call to emergency services. Presently, the party needing the emergency assistance would have to break the connection with the other party in order to dial 911. This may be undesirable in certain scenarios. For example, a child could be scared and place a call to a parent to discuss an event. The parent may decide that an emergency call is advisable and tell the child to hang up and dial 911. To do so completely cuts out the parent from communications with the 911 dispatcher. Accordingly, the carrier system 360 may be adapted to bridge an appropriate PSAP 330 into the existing call with the proper caller ID information for the dispatcher. Then, if two parties are on an existing call when one party determines that a call to 911 is needed, rather than hanging up and dialing 911, the party needing to make the emergency call may invoke a process that causes a call to 911 that gets joined to the existing call. The 911 dispatcher may be supplied the caller ID of the party needing the emergency services. This would allow, for example, a parent to assist a child in communicating with a dispatcher while first responders are sent to the location of the child. There could be a medical emergency and the parent may be in a better position to relay pertinent information to the dispatcher or to keep the child calm while the child describes the scene for the dispatcher.

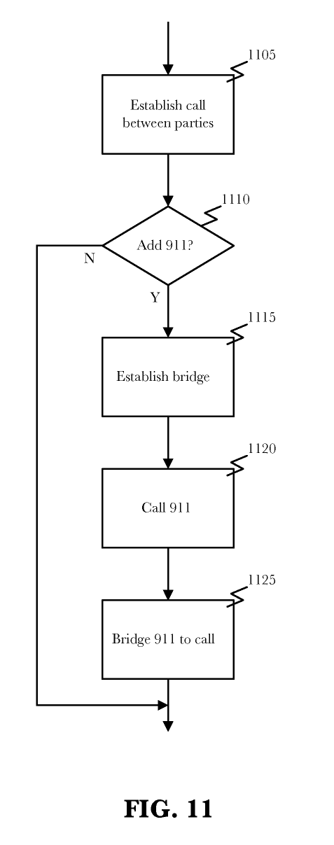

FIG. 11 is a flowchart illustrating a process for bridging an emergency call to an established call between parties according to one embodiment of the present invention. As illustrated in this example, bridging an emergency call to an established call between parties may include establishing at block 1105 a call between the parties. A determination may be made as to whether to add an emergency call at block 1110, e.g., an emergency call conference option may be selected. In response to determining 1110 to add the emergency call, a bridge may be established at block 1115 and the emergency call may be made at block 1120 and bridged at block 1125 to the established call without causing the original parties to disconnect.

Embodiments of the present invention may also include a process that allows the user to take a file of information, apply an encoding algorithm to reduce the file size, store the encoded data, and apply a decoding algorithm to restore the file to its original state. This process may be performed, for example, to produce a file or message that is more efficient for transmission to or from and storage on a mobile device. The creation of the data file may be accomplished through the use of a software application resident on a computer such as, for example, the carrier system 360 or mobile device 305. Once a file is created, an encoding algorithm may be applied by the carrier system 360 or mobile device 305 to reduce its size and prevent viewing the information in an understandable format. A new, encoded file and/or string of bytes may be created in the process. This is typically done on the computer that created the file as a post-creation process.

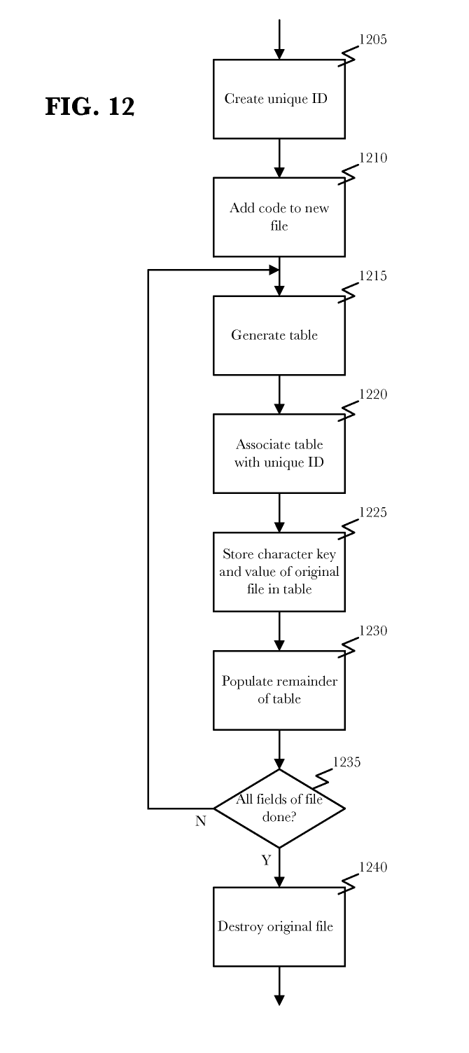

FIG. 12 is a flowchart illustrating a process for encoding a message related to an emergency call according to one embodiment of the present invention. As illustrated in this example, the first step in the process may be the creation at block 1205 of a unique identifier for the original file. This identifier may be embedded somewhere in the new, encoded file. Since this identifier is indistinguishable from other information stored in the new file it is not easily detectible. It may also be used for correctly locating and identifying the generated tables used to decode the file.

A code containing one or more characters may be placed at block 1210 in the new, encoded file that corresponds to the value in the original file. Since mobile communications devices may process certain ASCII characters in an unpredictable fashion, viewable characters including the 26 letters in the English alphabet and the numbers 0 through 9 might be used for this replacement process.

A table may be generated at block 1215 for this field. The table may include multiple rows each corresponding to the collating sequence for every possible combination of one or more characters chosen from the 26 characters of the alphabet and the numbers 0 through 9. Each table may have a unique identifier associated with it at block 1220. In one of the tables, the one or more character key and the value from the original file may be stored in one of the table rows at block 1225. The other rows in this table and other tables may be populated at block 1230 with similar, valid values. This process hides the only actual value among a large number of other possible combinations.

The first field may be the association of the table identifier for the field with the unique identifier for the file established at the very beginning of the process.

These steps may then be repeated at block 1235 for other fields in the file.

After the encoding process has been completed, the original file may be destroyed. The new, encoded file may then be stored on the mobile device 305 in a dramatically reduced space and, while the characters in the file may be read, they disclose no sensitive information. The set of tables may be stored with the processor that is used to decode the data, e.g., the carrier system 360.

Because the file size has now been dramatically reduced, several options are available for transmitting the file to other devices and systems. Even with the severe limitation of Short Message Service (SMS) of 160 characters and other mechanisms for delivering the information, it may be used to encode and send very large files that have been encoded to systems capable of decoding them. Email and other file transfer utilities have less onerous restrictions on file size, however, the encoding process described still allows for faster transfer due to the smaller file size and data privacy.

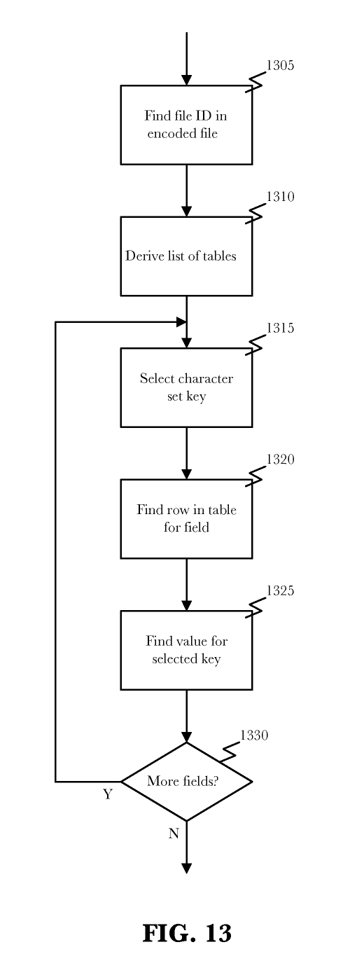

FIG. 13 is a flowchart illustrating a process for decoding a message related to an emergency call according to one embodiment of the present invention. As illustrated in this example, the encoded file may be presented to the decoding algorithm. The decoding function may find the file identifier hidden in the file at block 1305. Using the identifier, it may derive at block 1310 the list of tables that contain the actual values for recreating the original file.

The decoding algorithm may then select at block 1315 the first character set (one or more characters) key and may use it to find at block 1320 the correct row in the table established for that field. The value may be found at block 1325 in the second column of the row containing the first character set (one or more characters) key in the first column. This process may be repeated at block 1330 for each of the fields in the file.

The encoded file and the set of tables associated with the file identifier may be kept separate. The encoded file may be made up of a string of characters with no actual information making it useless to unauthorized viewers. The tables created for each field may be read, however, without the file identifier AND the first character set (1 or more characters) keys for each filed, it is impossible to reconstruct the file. It is only when these two sets of information come together that the original file may be reconstructed.

It is not necessary to create a new set of tables for each field for each file. Tables may be created that contain valid associations between the first character set (1 or more characters) keys and field values for multiple files. In fact, as more files are encoded using this technique, the valid associations may be used to populate the tables reducing the need to create associations. However, care should be given to mix key and valid values from different users randomly so that patterns do not emerge.

To enhance the privacy and security of the data, two extensions to the basic process may be made. First, each table that hides true values for different users may be proposed as a single column. Multiple columns may be used each with the true values for multiple fields and multiple users. This buries the value for a single user deeper and makes it harder to deduce. Second, each of these tables may reside on different servers that are geographically dispersed. To ensure the availability of the tables when they are needed to decode the user encoded file, there may be at least two instances of the table each on a different system. Both of these enhancements to the basic method use another file created at the time of the encoding. This new small file correlates the key identifying the user with pointers to the tables that contain the true values for each encoded value, the column within the table, and an identifier that points to the primary, secondary, and any additional servers holding the tables.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

1. A method of placing an emergency call from a mobile device comprising:
detecting a first location indication for the current location of the mobile device making the emergency call;
routing the emergency call and the first location indication to a public safety system for handling the emergency call, the public safety system selected from a plurality of public safety systems based at least in part on the first location indication;
detecting a second location indication for the current location of the mobile device making the emergency call, wherein the first location indication is available sooner than the second location indication but the second location indication is a more accurate indication of the current location of the mobile device; and
routing the second location indication for the current location of the mobile device to the public safety system handling the emergency call.

2. The method of claim 1, wherein the first location indication is based on a location determination made by one of a GPS receiver in the mobile device or a system of a service provider supporting the mobile device.

3. The method of claim 2, wherein the system of a service provider supporting the mobile device comprises a cell site triangulation system.

4. The method of claim 2, wherein the second location indication is generated by an application executing on the mobile device wherein the application detects a connection with a known computer and determines the second location information based on a predefined location for the known computer.

5. The method of claim 2, wherein the second location indication is based on information from a combination of sensor data in the mobile device and map information.

6. The method of claim 2, wherein the second location indication is based on a database of subscriber information maintained by a system of a service provider supporting the mobile device and wherein the database of subscriber information includes location information for the mobile device.

7. The method of claim 2, wherein the second location indication is based on a wireless access point with which the mobile device is connected.

8. The method of claim 2, wherein the second location indication is based on wireless access point IP location data provided by an IP location vendor.

9. The method of claim 2, wherein the second location indication is based on information from a combination of an altimeter of the mobile device and map information.

10. A system comprising:
a processor; and
a memory coupled with and readable by the processor and storing therein a set of instructions which, when executed, cause the processor to determine a current location of a mobile device making an emergency call by:
detecting a first location indication for the current location of the mobile device making the emergency call;
routing the emergency call and the first location indication to a public safety system for handling the emergency call, the public safety system selected from a plurality of public safety systems based at least in part on the first location indication;
detecting a second location indication for the current location of the mobile device making the emergency call, wherein the first location indication is available sooner than the second location indication but the second location indication is a more accurate indication of the current location of the mobile device; and
routing the second location indication for the current location of the mobile device to the public safety system handling the emergency call.

11. The system of claim 10, wherein the first location indication is based on a location determination made by one of a GPS receiver in the mobile device or a system of a service provider supporting the mobile device.

12. The system of claim 11, wherein the system of a service provider supporting the mobile device comprises a cell site triangulation system.

13. The system of claim 11, wherein the second location indication is generated by an application executing on the mobile device wherein the application detects a connection with a known computer and determines the second location information based on a predefined location for the known computer.

14. The system of claim 11, wherein the second location indication is based on information from a combination of sensor data in the mobile device and map information.

15. The system of claim 11, wherein the second location indication is based on a database of subscriber information maintained by a system of a service provider supporting the mobile device and wherein the database of subscriber information includes location information for the mobile device.

16. The system of claim 11, wherein the second location indication is based on wireless access point with which the mobile device is connected.

17. The system of claim 11, wherein the second location indication is based on wireless access point IP location data provided by an IP location vendor.

18. The system of claim 11, wherein the second location indication is based on information from a combination of an altimeter of the mobile device and map information.

19. A computer-readable memory comprising a set of instructions stored therein which, when executed by a processor, causes the processor to determine a current physical location of a mobile device making an emergency call by:
detecting a first location indication for the current location of the mobile device making the emergency call;
routing the emergency call and the first location indication to a public safety system for handling the emergency call, the public safety system selected from a plurality of available public safety systems based at least in part on the first location indication;
detecting a second location indication for the current location of the mobile device making the emergency call, wherein the first location indication is available sooner than the second location indication but the second location indication is a more accurate indication of the current location of the mobile device; and
routing the second location indication for the current location of the mobile device to the public safety system handling the emergency call.

20. The computer-readable memory of claim 19, wherein the first location indication is based on a location determination made by one of a GPS receiver in the mobile device or a system of a service provider supporting the mobile device.

21. The computer-readable memory of claim 20, wherein the system of a service provider supporting the mobile device comprises a cell site triangulation system.

22. The computer-readable memory of claim 20, wherein the second location indication is generated by an application executing on the mobile device wherein the application detects a connection with a known computer and determines the second location information based on a predefined location for the known computer.

23. The computer-readable memory of claim 20, wherein the second location indication is based on information from a combination of sensor data in the mobile device and map information.

24. The computer-readable memory of claim 20, wherein the second location indication is based on a database of subscriber information maintained by a system of a service provider supporting the mobile device and wherein the database of subscriber information location information for the mobile device.

25. The computer-readable memory of claim 20, wherein the second location indication is based on a wireless access point with which the mobile device is connected.

26. The computer-readable memory of claim 20, wherein the second location indication is based on wireless access point IP location data provided by an IP location vendor.

27. The computer-readable memory of claim 20, wherein the second location indication is based on information from a combination of an altimeter of the mobile device and map information.
